(19) United States
(12) Patent Application Publication
(10) Pub. No.: US 2026/0175393 A1
(43) Pub. Date: Jun. 25, 2026

(54) Lock for a rechargeable battery

(71) Applicant: Hilti Aktiengesellschaft, Schaan (LI)

(72) Inventors: Klaus HAUSER, Schwabmünchen (DE); Daniel SELTMANN, Türkheim (DE); Moses ENDER, Kaufering (DE); Mathias FRENZEL, Unterdießen (DE); Markus HARTMANN, Mauerstetten (DE); Robert STANGER, Kaufbeuren (DE); Markus HOLUBARSCH, Landsberg am Lech (DE)

(21) Appl. No.: 19/126,435

(22) PCT Filed: Oct. 24, 2023
(86) PCT No.: PCT/EP2023/079672

§ 371 Date: May 1, 2025

(30) Foreign Application Priority Data
Nov. 8, 2022 (EP) 22206047.7

(51) Int. Cl. B25F 5/00; B25F 5/02; H01M 50/204; H01M 50/244; H01M 50/247; H01M 50/296

(52) U.S. Cl. CPC B25F 5/00; B25F 5/02; H01M 50/204; H01M 50/244; H01M 50/247; H01M 50/296; H01M 2220/30

(57) ABSTRACT

A system (100) having a power tool and at least one rechargeable battery as an energy supply for the power tool having at least one energy storage element, including a locking apparatus having at least one locking element for releasably connecting the at least one rechargeable battery to the power tool. The locking apparatus includes at least one actuator for reversibly moving the at least one locking element from a first position into a second position, wherein, in the first position, the rechargeable battery may be moved relative to the power tool and, in the second position, the rechargeable battery is immovably connected to the power tool.

The present invention relates to a system having a power tool and at least one rechargeable battery.

Furthermore, the present invention relates to a rechargeable battery for use in a system having a power tool.

Moreover, the present invention relates to a power tool for use in a system having at least one rechargeable battery.

Furthermore, the present invention relates to a method for controlling a locking apparatus in a system including a power tool and at least one rechargeable battery.

### BACKGROUND

Rechargeable batteries are widely known in the prior art as an energy supply for a power tool. These rechargeable batteries include a number of energy storage elements (also referred to as energy storage cells or battery cells), which serve and are designed to receive, store, and deliver electrical energy. The receiving of electrical energy into the energy storage elements can also be referred to as charging. The delivery of electrical energy from the energy storage elements can also be referred to as discharging.

### SUMMARY OF THE INVENTION

A problem when using the rechargeable battery in a power tool is the unwanted or unavoidable relative movement between the rechargeable battery and the power tool. The relative movement between the rechargeable battery and the power tool may result in wear on the contacts and excessive heating of the contacts. The transfer of electrical energy from the rechargeable battery to the power tool may therefore be impaired or reduced.

It is an object of the present invention to solve the problem described above.

The present invention provides a system having a power tool and at least one rechargeable battery as an energy supply for the power tool having at least one energy storage element, including a locking apparatus having at least one locking element for releasably connecting the at least one rechargeable battery to the power tool.

According to the invention, it is provided that the locking apparatus includes at least one actuator for reversibly moving the at least one locking element from a first position into a second position, wherein, in the first position, the rechargeable battery may be moved relative to the power tool and, in the second position, the rechargeable battery is immovably connected to the power tool.

The actuator here can be configured, in particular, in the form of an electromechanical actuator. Alternatively, the actuator can also be configured as a hydraulic or pneumatic actuator.

The term “immovably” in connection with the second position means that a relative movement between the rechargeable battery and the power tool is restricted to a minimum or a relative movement between the rechargeable battery and the power tool cannot take place.

According to an advantageous exemplary embodiment, it may be possible that the at least one actuator can be activated via an activating device. The activating device can be operated by a user of the power tool via an input panel. The input panel can be configured as at least one switch on an outer wall of the housing of the rechargeable battery.

According to a further advantageous exemplary embodiment, it may be possible that the at least one actuator can be activated via at least one sensor. The at least one sensor can be an acceleration sensor, movement sensor, displacement sensor, position sensor or the like.

According to a further advantageous exemplary embodiment, it may be possible that the locking apparatus includes at least one drive for a translatory movement of the at least one locking element. The drive here can be configured in the form of a rotary drive or linear drive.

The rotary drive here can be configured with at least one cam.

The linear drive serves, in particular, to generate a translatory movement and can be configured, for example, in the form of a lifting appliance, a winch, a toothed rack, a rigid chain, a traction drive, a cam disk, a piezo motor, a folding spindle, a threaded spindle, an electric cylinder, a ball screw or a roller screw. The roller screw here can be configured, in particular, as a roller screw with roller recirculation or with a planetary roller screw.

Moreover, the linear drive can also be configured in the form of a hydraulic cylinder or a pneumatic cylinder.

It is moreover possible that the linear drive is also electromechanical in design. The electromechanical linear drive here can be configured, for example, in the form of a linear motor with an electrodynamic operating principle or as a linear actuator. The linear actuator here can be configured with a piezoelectric, electrostatic, electromagnetic, magnetostrictive or thermoelectric operating principle.

According to an advantageous exemplary embodiment, it may be possible that at least one acceleration sensor is included to detect at least one acceleration value, wherein the at least one acceleration sensor is connected to the locking apparatus so that the at least one locking element is moved into the first position and electrical energy can no longer be transmitted from the at least one rechargeable battery to the power tool if a detected acceleration value reaches a predetermined threshold value.

The acceleration sensor can be configured in the form of a gyro sensor.

Moreover, the present invention provides rechargeable battery for use in a system having a power tool.

According to a further advantageous exemplary embodiment, it may be possible that the rechargeable battery includes at least one acceleration sensor to detect at least one acceleration value, wherein the at least one acceleration sensor is connected to the locking apparatus so that the at least one locking element is moved into the first position and electrical energy can no longer be transmitted from the at least one rechargeable battery to the power tool if a detected acceleration value reaches a predetermined threshold value.

Furthermore, the present invention provides power tool for use in a system having at least one rechargeable battery.

According to a further advantageous exemplary embodiment, it may be possible that the power tool includes at least one acceleration sensor to detect at least one acceleration value, wherein the at least one acceleration sensor is connected to the locking apparatus so that the at least one locking element is moved into the first position and electrical energy can no longer be transmitted from the at least one rechargeable battery to the power tool if a detected acceleration value reaches a predetermined threshold value.

Moreover, the present invention provides a method for controlling a locking apparatus in a system including a power tool and at least one rechargeable battery as an energy supply for the power tool, wherein the locking apparatus includes at least one actuator for reversibly moving at least one locking element from a first position into a second or third position.

According to the invention, it is provided that the method includes the method steps:
detecting at least one acceleration value via an acceleration sensor;
comparing the at least one detected acceleration value to at least one first and second threshold value;
emitting at least one first signal to the actuator to switch the locking element from the first to the second position if the at least one detected acceleration value corresponds to the first threshold value; and
emitting at least one second signal to the actuator to switch the locking element from the first to the third position if the at least one detected acceleration value corresponds to the second threshold value.

Further advantages can be found in the following description of the figures. A particularly preferred exemplary embodiment of the present invention is illustrated in the figures. The figures, the description, and the claims include numerous features in combination. A person skilled in the art will expediently also consider the features individually and combine them to form sensible further combinations.

### BRIEF DESCRIPTION OF THE DRAWINGS

Identical and similar components are denoted by the same reference signs in the figures.

in which:

FIG. 1 shows a side view of a system according to the invention, which comprises a power tool and a rechargeable battery;

FIG. 2 shows a side view of a rechargeable battery according to the invention, with a schematically illustrated locking apparatus in a first position;

FIG. 3 shows a side view of the rechargeable battery according to the invention, with the schematically illustrated locking apparatus in a second position;

FIG. 4 shows a side view of the rechargeable battery according to the invention, with the locking apparatus according to a first exemplary embodiment in a first position;

FIG. 5 shows a side view of the rechargeable battery according to the invention, with the locking apparatus according to a first exemplary embodiment in a second position;

FIG. 6 shows a side view of the rechargeable battery according to the invention, with the locking apparatus according to a second exemplary embodiment in a first position; and

FIG. 7 shows a side view of the rechargeable battery according to the invention, with the locking apparatus according to a second exemplary embodiment in a second position.

### DETAILED DESCRIPTION

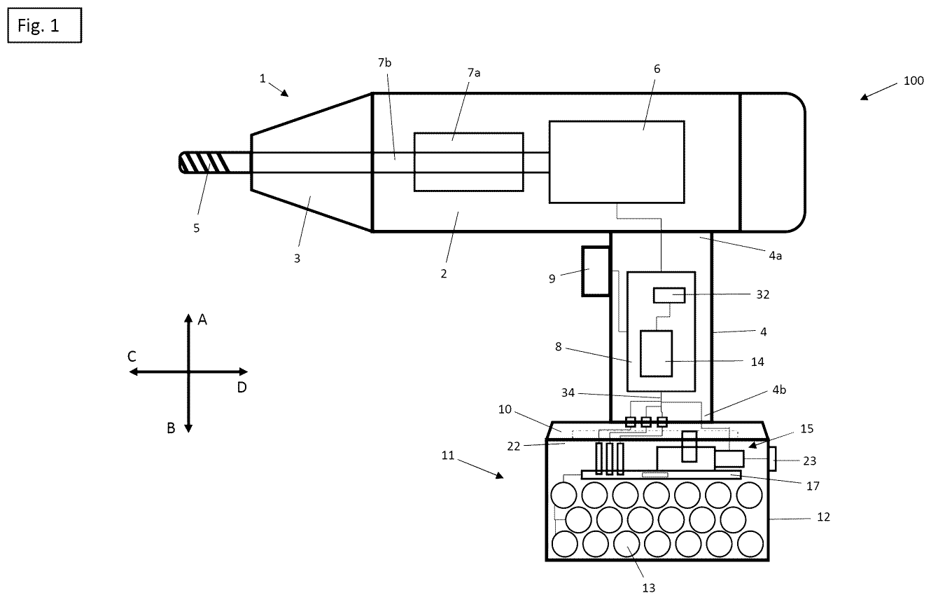

FIG. 1 shows a system 100 having a power tool 1 and a rechargeable battery 11 according to an exemplary embodiment.

The power tool 1 is configured as a power drill in the embodiment shown. Alternatively, the power tool 1 can also be configured as a power drill, a hammer drill, a saw, a grinder, or the like.

As indicated in FIG. 1, the power tool 1 configured as a power drill substantially includes a power tool housing 2 with a tool fitting 3 and a handle 4.

The tool fitting 3 serves to receive and retain a tool 5. The tool 5 is a drill bit in the present exemplary embodiment. Alternatively, the tool 5 can also be configured as a screwdriver bit.

A drive 6, a transmission 7a, an output shaft 7b, and a control unit 8 are, inter alia, provided in the interior of the power tool housing 2. The drive 6 is configured, for example, as a brushless electric motor and serves to generate torque.

The control unit 8 furthermore includes an acceleration sensor 14 for detecting acceleration values. The acceleration sensor 14 serves, in particular, to detect or measure accelerations in the event that the system 100 is dropped. The acceleration values detected by the acceleration sensor 14 are sent to the control unit 8 and evaluated. The control unit 8 moreover includes a memory 32, in which threshold values for the acceleration values are stored. If the acceleration sensor 14 detects an acceleration of the system 100, the value of the acceleration is assessed with the aid of the control unit 8. To this end, the detected acceleration value is compared with the threshold values stored in the memory. When a threshold value is reached, a corresponding signal is emitted by the control unit 8.

The control unit 8 controls in a closed and open loop the functions and the behavior of the power tool 1 and in particular the drive 6.

The handle 4 in turn includes an actuating switch 9, an upper end 4a, and a lower end 4b. The actuating switch 9 is connected to the control unit 8 such that actuating the actuating switch 9 results in an activation of the drive 6 or the power tool 1.

As also shown in FIG. 1, the drive 6, the transmission 7a, the output shaft 7b, and the tool fitting 3 are arranged relative to one another such that torque generated by the drive 6 can be transmitted to the tool fitting 3 via the transmission 7a and the output shaft 7b. The torque generated by the drive 6 is ultimately transmitted to the tool 5 by the tool fitting 3.

The power tool housing 2 furthermore has an upper side 2a, a lower side 2b, a front end 2c, and a rear end 2d.

The tool fitting 3 is positioned at the front end 2c. The upper end 4a of the handle 4 is fastened to the lower side 2b and in the vicinity of the rear end 2d of the power tool housing 2. A power-tool interface 10 is positioned at the lower end 4b of the handle 4. The power-tool interface 10 is used for releasably connecting the power tool 1 to the accumulator 11.

According to an alternative exemplary embodiment (not shown in the figures), the power tool can also be configured such that it is connected to more than one rechargeable battery 11 as an energy source.

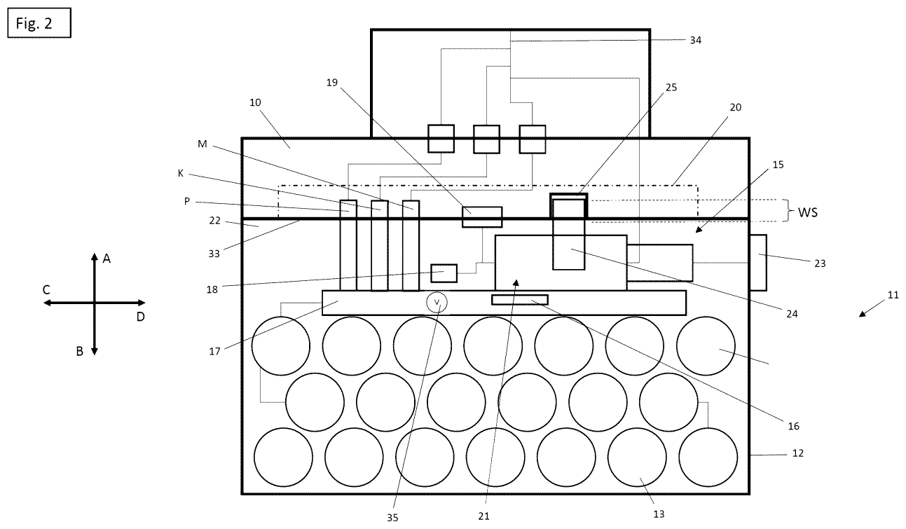

The rechargeable battery 11 described in the exemplary embodiment can be used in particular as an energy storage apparatus or electrical energy source for the power tool 1. The rechargeable battery 11 here substantially includes a battery housing 12, a number of energy storage elements 13, a storage apparatus 16, a battery interface 22, a locking apparatus 15 and a control device 17. Furthermore, the rechargeable battery 11 includes an acceleration sensor 18 and a displacement sensor 19 (see, e.g, FIG. 2). The displacement sensor 19 can also be referred to as a distance sensor or position sensor. In the present exemplary embodiments, the displacement sensor 19 is configured in the form of a strain gauge. Alternatively or in addition to the strain gauge, the displacement sensor 19 can also be configured in the form of a potentiometric transducer, an inductive sensor, a capacitive sensor and/or and inductive sensor (e.g. differential transformer (LVDT), transverse armature transducer, short-circuit ring transducer, magneto-inductive displacement sensor (MDS) or eddy current sensor).

The acceleration sensor 18 can also be referred to as an accelerometer, acceleration pickup, vibration pickup, oscillation pickup, acceleration meter or G-sensor. In the present exemplary embodiments, the acceleration sensor 18 is configured as a MEMS acceleration and gyro sensor (MEMS=micro-electro-mechanical system).

Alternatively or in addition, the acceleration sensor 18 can also be configured as a piezoelectric acceleration sensor, strain gauge, magnetic induction sensor or Ferraris sensor.

The energy storage elements 13 can also be referred to as battery cells. According to an alternative exemplary embodiment (not shown in the figures), the rechargeable battery 11 may include only one energy storage element 13.

The storage apparatus 16 is positioned in the interior of the rechargeable battery housing 12 and is used to store and provide data and information.

The battery interface 22 serves to electrically or electronically connect the rechargeable battery 11 to the power tool 1 by means of the power-tool interface 10. To this end, the battery interface 22 includes a positive contact P, a negative contact M and a communication contact K. The positive contact P and negative contact M serve to transmit electrical energy from the energy storage elements of the rechargeable battery 11 to the consumers (in particular the drive 6) of the power tool 1. The communication contact K in turn serves for the communication between the control device 17 of the rechargeable battery 11 and the control unit 8 of the power tool 1. For the communication between the rechargeable battery 11 and the power tool 1, data and information are exchanged in the form of signals.

The energy storage elements 13 serve to receive, store and deliver electrical energy again. As indicated in the figures, the energy storage elements 13 are cylindrical in shape and configured on the basis of lithium-ion technology.

Alternatively, the energy storage elements 13 can also be based on another suitable technology. The cylindrical shape of the energy storage elements 13 is likewise optional, which means that any other suitable shape or geometry can also be selected. For example, it is, in particular, also possible that the energy storage elements 13 are embodied as pouch cells.

To releasably mechanically couple the rechargeable battery 11 to the power tool 1, the system 100 includes a rail apparatus 20. As indicated in the figures, the rail apparatus 20 is positioned between the battery interface 22 and the power-tool interface 10 such that the rechargeable battery 11 can be slid along the rail apparatus 20 and onto the power tool 1 in the direction of arrow C and removed (slid off) from the power tool 1 again in the direction of arrow D. When the rechargeable battery 11 is coupled to the power tool 1 with the aid of the rail apparatus 20, the positive contact P, the negative contact M and the communication contact K of the rechargeable battery 11 are in contact with the corresponding positive and negative contacts P, M and the communication contact K of the power tool 1. Electrical energy and electrical signals can then be transmitted from the rechargeable battery 11 to the power tool 1.

The locking apparatus 15 (see, e.g, FIG. 1) serves to releasably connect the rechargeable battery 11 to the power tool 1. To this end, the locking apparatus 15 substantially includes an actuator 21, an activating device 23 and a locking element 24 (see, e.g., FIG. 2).

In FIGS. 1 to 3, the locking apparatus 15 according to a first embodiment is shown in the interior of the rechargeable battery 11. Alternatively, the locking apparatus 15 according to the first embodiment can also be positioned in the interior of the power tool 1.

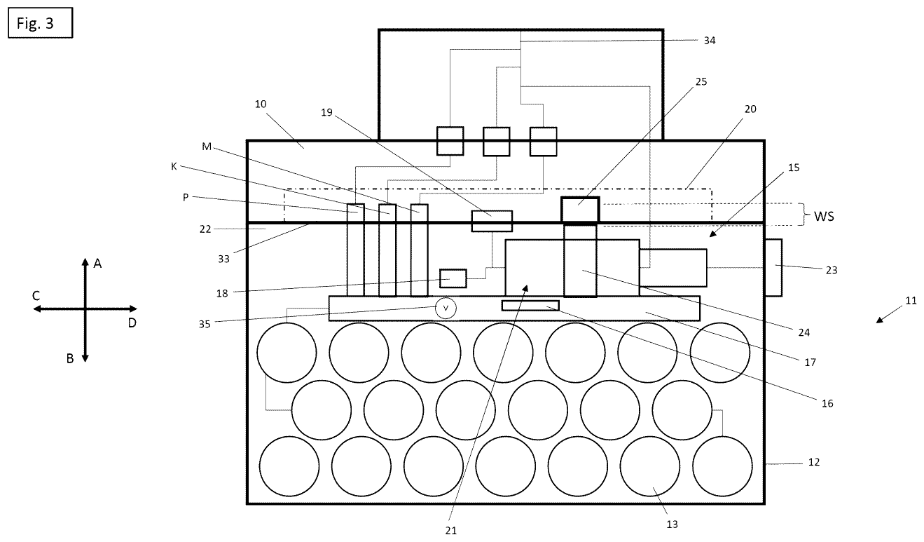

In the locking apparatus 15 according to the first embodiment, the actuator 21 is configured and positioned such that the locking element 24 can be reversibly moved from a first position into a second position by means of the actuator 21. In FIGS. 1 and 2, the locking element 24 is shown in the first position. In FIG. 3, the locking element 24 is illustrated in the second position.

As indicated in FIGS. 1 and 2, the actuator 21, the activating device 23 and the locking element 24 are arranged with respect to each other and connected to each other such that a corresponding signal can be sent to the actuator 21 via the activating device 23.

In the present exemplary embodiment, the activating device 23 is configured as an input device with an actuating switch. One or more actuating switches can be provided here. By actuating the actuating switch, a corresponding signal is emitted.

After receiving the predetermined signal, the actuator 21 moves the locking element 24. The actuator 21 here can move the locking element 24 in direction A or B, over either the entire distance WS or only part of the distance. Moreover, the actuator 21 can move the locking element 24 incrementally in the same direction A or B or the actuator 21 moves the locking element 24 in a first direction (for example, direction A) and then in an opposite direction (for example, direction B).

In FIG. 2, the locking element 24 is in the first position, wherein the locking element 24 is moved the entire distance WS in direction A by the actuator 24 and projects into a correspondingly configured recess 25 in the power-tool interface 10. As a result of the locking element 24 projecting into the recess 25 of the power-tool interface 10, the rechargeable battery 11 cannot be moved in direction D along the rail apparatus 20 and relative to the power tool 1. The rechargeable battery 11 is thus prevented from moving relative to the power tool 1 and is firmly connected to the power tool 1.

In order to in turn release or remove the rechargeable battery 11 from the power tool 1, a corresponding signal is sent to the actuator 21 by the activating device 23. To send the corresponding signal, the actuating switch 9 is pressed again. After receiving the signal, the actuator 21 moves the locking element 24 over the entire distance WS in direction B, so that the locking element 24 no longer projects into the recess 25 of the power-tool interface 10. The rechargeable battery 11 is thus no longer blocked from moving along the rail apparatus 20 and relative to the power tool 1, so that the rechargeable battery 11 can be slid from the power tool 1 in direction D.

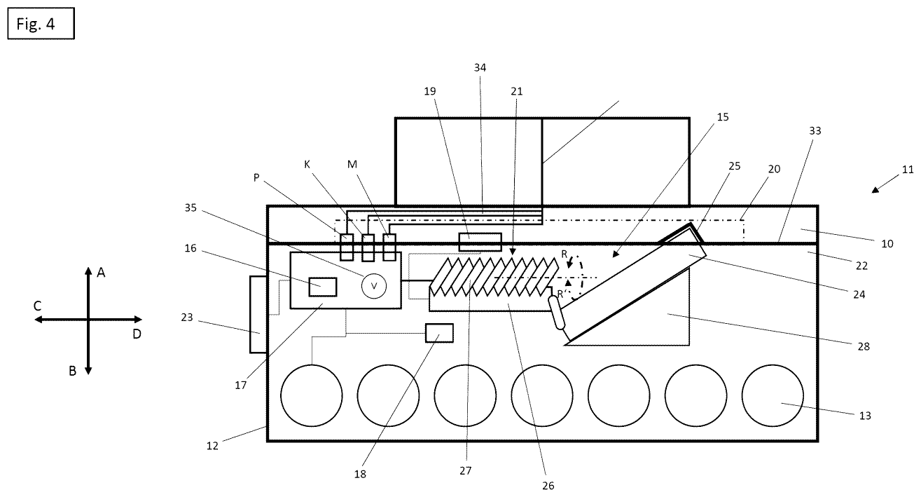

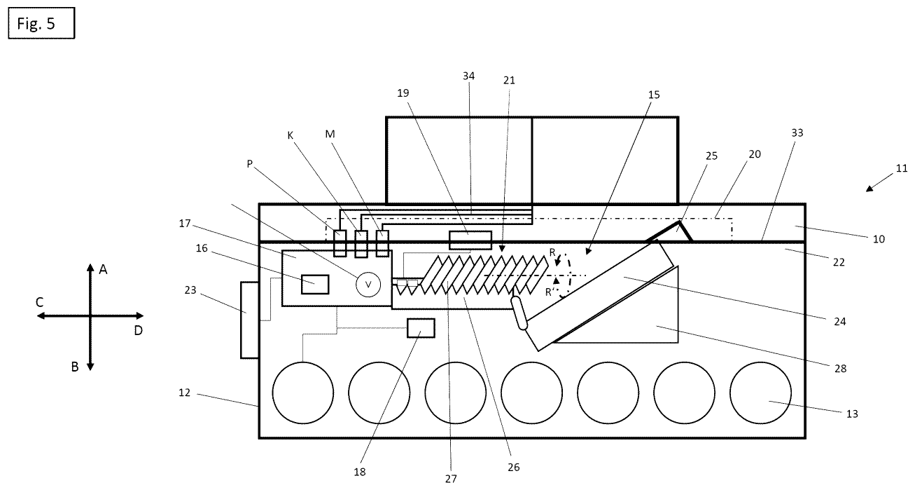

In FIGS. 4 to 5, the locking apparatus 15 according to a second embodiment is shown in the interior of the rechargeable battery 11. Alternatively, the locking apparatus 15 according to the second embodiment can also be positioned in the interior of the power tool 1.

The actuator 21 according to the second embodiment is configured in the form of a linear drive. The linear drive here substantially includes a toothed rack 26 and a worm gear shaft 27. The toothed rack 26 and the worm gear shaft 27 here are positioned or arranged with respect to each other such that, by rotating the worm gear shaft 27 about a longitudinal axis, the toothed rack 26 can be moved. If the worm gear shaft 27 is rotated in a first direction of rotation R, the toothed rack 26 is moved in direction D. By rotating the worm gear shaft 27 in a second direction of rotation R′, the toothed rack 26 moves in direction C. As shown in FIGS. 4 and 5, the worm gear shaft 27 is connected to the control device 17. The control device 17 is in turn connected to the activating device 23. An actuation of the activating device 23 results in a signal being sent to the control device 17 and ultimately to the actuator 21. The toothed rack 26 is connected to the locking element 24 by one end such that the locking element 24 is slid along a ramp of a wedge element 28 if the toothed rack 26 is moved in direction D. An upper end of the locking element 24 is thus moved in direction A and into a corresponding recess 25 in the power-tool interface 10, c.f. FIG. 4. If the locking element 24 is inserted entirely into the recess 25, a relative movement between the rechargeable battery 11 and the power tool 1 is prevented. If the worm gear shaft 27 is rotated in direction of rotation R′, the toothed rack 26 moves in direction C. The locking element 24 is thus moved downwards along the ramp in direction B and therefore moves entirely out of the recess 25. With the aid of the activating device 23, the toothed rack 26 can be moved in repeated increments in direction C or in repeated increments in direction D.

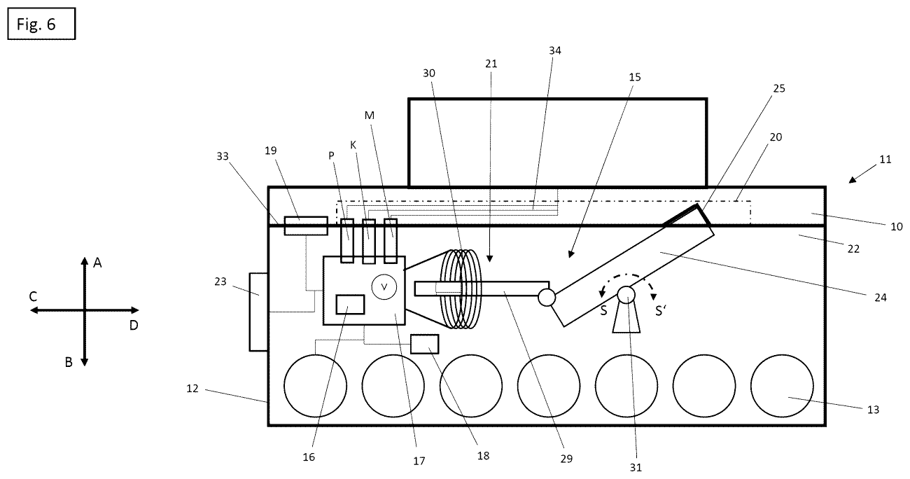

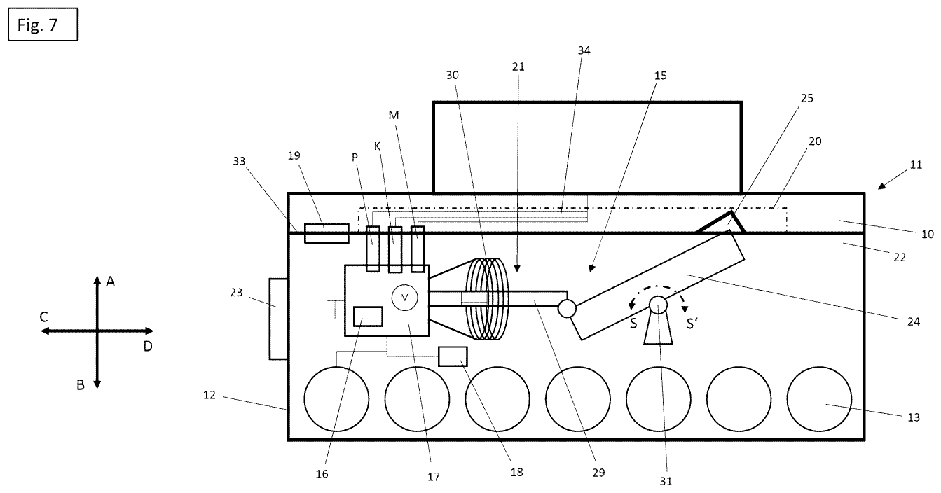

In FIGS. 6 and 7, the locking apparatus 15 according to a third embodiment is shown inside the rechargeable battery 11. Alternatively, the locking apparatus 15 according to the third embodiment can likewise be positioned inside the power tool 1.

The actuator 21 according to the third embodiment is likewise configured in the form of a linear drive. However, the linear drive according to the third embodiment is configured with an electrodynamic operating principle and substantially includes a magnetic thrust rod 29 and a coil 30. The coil 30 is connected to the control device 17 such that electrical energy can be conducted through the coil 30 so that the magnetic thrust rod 29 is moved either in direction C or D. One end of the thrust rod 29 is connected to one end of the locking element 24. The locking element 24 is mounted to be pivotable about a pivot point 31, so that the locking element 24 is pivoted in the direction of rotation S if the thrust rod 29 moves in direction C.

If the thrust rod 29 moves in direction D, the locking element 24 is pivoted in direction of rotation S′. As can be seen in FIGS. 6 and 7, one end of the pivotable locking element 24 moves in direction A and into a recess 25 in the power-tool interface 10 if the thrust rod 29 rotates in direction C and the locking element 24 rotates in the direction of rotation S, FIG. 6. The rechargeable battery 11 is then firmly connected to the power tool 1 so that relative movements between the rechargeable battery 11 and the power tool 1 are prevented.

If the thrust rod 29 moves in direction C, the locking element 24 is pivoted in direction of rotation S. As can be seen in FIGS. 6 and 7, one end of the pivotable locking element 24 moves in direction B and out of the recess 25 in the power-tool interface 10, c.f. FIG. 7. The rechargeable battery 11 is then no longer firmly connected to the power tool 1, so that the rechargeable battery 11 and the power tool 1 can be separated from each other.

The acceleration sensor 18 of the rechargeable battery 11 is connected to the control device 17 so that acceleration values detected by the acceleration sensor 18 can be sent to the control device 17. Threshold or limit values for an acceleration are stored in the storage apparatus 16. If the detected acceleration values reach the predetermined threshold values, a signal is sent by the control device 17 to the actuator 21 so that the locking element is pushed further into the corresponding recess 25 of the power-tool interface 10. The rechargeable battery 11 is thus even more firmly connected to the power tool 1.

The displacement sensor 19 is positioned on an upper side face 33 of the battery housing 12. If the rechargeable battery 11 is connected to the power tool 1, the displacement sensor 19 is positioned between the rechargeable battery 11 and the power tool 1 such that the displacement between the rechargeable battery 11 and the power tool 1 can be detected as displacement values (e.g. in millimeters (mm)). Threshold or limit values for a displacement between the rechargeable battery 11 and the power tool 1 are stored in the storage apparatus 16. If the detected displacement values reach the predetermined threshold values, a signal is sent by the control device 17 to the actuator 21 so that the locking element is pushed further into the corresponding recess 25 of the power-tool interface 10. The rechargeable battery 11 is thus even more firmly connected to the power tool 1.

Moreover, the displacement sensor 19 can serve to activate the actuator 21, and consequently the locking element 24, if the rechargeable battery 11 assumes a certain position with respect to the power tool 1. In other words: if the rechargeable battery 11 is slid entirely onto the rail apparatus 20 and has assumed its correct position or arrangement with respect to the power tool 1, this can be detected by the displacement sensor 19.

As is likewise shown in FIGS. 1 to 3, the actuator 21 is also connected to the control unit 8 via a line 34, so that signals can be received by the control unit 8. In the event of a sudden and relatively high acceleration of the system 100, a value for the acceleration (i.e. acceleration value) is detected with the aid of the acceleration sensor 14 of the power tool 1. In the control unit 8 of the power tool 1, the detected acceleration value is compared with the threshold values stored in the memory of the control unit 8. If it can be ascertained from the comparison that the detected acceleration value has reached a predetermined threshold value, a corresponding signal is sent by the control unit 8 to the actuator 21 of the locking apparatus 15 via the line 34. As a result of the received signal, the actuator 21 moves the locking element 24 further in direction A so that the rechargeable battery 11 is pushed further into the rail apparatus 20 and is therefore also more firmly connected to the power tool 1. As a consequence of this, relative movements between the rechargeable battery 11 and the power tool 1 are prevented.

Moreover, an acceleration which acts on the power tool 1 is compared with an acceleration which acts on the rechargeable battery 11. To this end, the acceleration value which is detected by the acceleration sensor 14 of the power tool 1 is compared with the acceleration value which is detected by the acceleration sensor 18 of the rechargeable battery 11. The acceleration value for the power tool 1 is sent as a signal to the control device 17 of the rechargeable battery 11 via the line 34. The control device 17 likewise receives the acceleration values of the acceleration sensor 18 of the rechargeable battery 11. By comparing the acceleration values of the rechargeable battery 11 and the power tool 1, it can be established whether a difference between the acceleration values detected in each case corresponds to a predetermined threshold or limit value stored in the storage apparatus 16. If the ascertained difference corresponds to the predetermined threshold or limit value, this means that the power tool 1 and the rechargeable battery 11 are subject to too greatly differing accelerations (for example, in the form of vibrations), which may result in damage. As a consequence of this, a signal is sent to the actuator 21 by the control device 17, resulting in the locking element 24 being pushed further, and with greater force, into the recess 25 of the power-tool interface 10. As a result, a relative movement and differing accelerations between the rechargeable battery 11 and the power tool 1 can be counteracted.

According to a further exemplary embodiment, a voltage measuring device 35 is included in the rechargeable battery 11 to detect the electrical voltage of the energy storage elements 13. The voltage measuring device 35 is connected to the control device 17 such that detected voltage values can be sent by the voltage measuring device 35 to the control device 17. Threshold or limit values are stored in the storage apparatus 16. One type of threshold value defines a minimum voltage of the energy storage elements 13. If a detected voltage value reaches the threshold value which defines a minimum electrical voltage of the energy storage elements 13, a signal is sent by the control device 17 to the actuator 21, as a result of which the locking element 24 is removed from the recess 25 of the power-tool interface 10. The rechargeable battery 11 is thus released from the power tool 1, so that a minimum voltage of the energy storage elements 13 is displayed for a user of the power tool 1.

### LIST OF REFERENCE SIGNS

100 System
1 Power tool
2 Power tool housing
3 Tool fitting
4 Handle
4a Upper end of the handle
4b Lower end of the handle
5 Tool
6 Drive
7a Transmission
7b Output shaft
8 Control unit
9 Actuating switch
10 Power-tool interface
11 Rechargeable battery
12 Battery housing
13 Energy storage element
14 Acceleration sensor of the power tool
15 Locking apparatus
16 Storage apparatus
17 Control device
18 Acceleration sensor of the rechargeable battery
19 Displacement sensor
20 Rail apparatus
21 Actuator
22 Battery interface
23 Activating device
24 Locking element
25 Recess
26 Toothed rack
27 Worm gear shaft
28 Wedge element
29 Thrust rod
30 Coil
31 Pivot point
32 Memory of the power tool
33 Upper side face of the battery housing
34 Line
35 Voltage measuring device
P Positive contact
M Negative contact
K Communication contact
WS Distance

What is claimed is:

1-10. (canceled)

11. A system comprising:
a power tool; and
at least one rechargeable battery as an energy supply for the power tool and having at least one energy storage element, and including a locking apparatus including at least one lock for releasably connecting the at least one rechargeable battery to the power tool, and including at least one actuator for reversibly moving the at least one lock from a first position into a second position, wherein, in the first position, the rechargeable battery is movable relative to the power tool and, in the second position, the rechargeable battery is immovably connected to the power tool.

12. The system as recited in claim 11 wherein the at least one actuator is activatable via an activating device.

13. The system as recited in claim 11 wherein the at least one actuator is activatable via at least one sensor.

14. The system as recited in claim 11 wherein the locking apparatu includes at least one drive for a translatory movement of the at least one lock.

15. The system as recited in claim 11 further comprising at least one acceleration sensor to detect at least one acceleration value, wherein the at least one acceleration sensor is connected to the locking apparatus so that the at least one lock is moved into the first position and electrical energy is no longer be transmittable from the at least one rechargeable battery to the power tool if the acceleration value reaches a predetermined threshold value.

16. A rechargeable battery as an energy supply for a power tool and comprising:
at least one energy storage element; and
a locking apparatus including at least one lock for releasably connecting the at least one rechargeable battery to the power tool, and including at least one actuator for reversibly moving the at least one lock from a first position into a second position, wherein, in the first position, the rechargeable battery is movable relative to the power tool and, in the second position, the rechargeable battery is immovably connected to the power tool.

17. The rechargeable battery as recited in claim 16 further comprising at least one acceleration sensor to detect at least one acceleration value, wherein the at least one acceleration sensor is connected to the locking apparatus so that the at least one lock is moved into the first position and electrical energy is no longer be transmittable from the at least one rechargeable battery to the power tool if the acceleration value reaches a predetermined threshold value.

18. A power tool comprising:
a releasable connection with at least one rechargeable battery as an energy supply for the power tool and having at least one energy storage element, the rechargeable battery including a locking apparatus including at least one lock connecting the at least one rechargeable battery to the power tool at the releasable connection, the rechargeable battery including at least one actuator for reversibly moving the at least one lock from a first position into a second position, wherein, in the first position, the rechargeable battery is movable relative to the power tool and, in the second position, the rechargeable battery is immovably connected to the power tool.

19. The power tool as recited in claim 18 wherein at least one acceleration sensor detects at least one acceleration value, wherein the at least one acceleration sensor is connected to the locking apparatus so that the at least one lock is moved into the first position and electrical energy is no longer be transmittable from the at least one rechargeable battery to the power tool if the acceleration value reaches a predetermined threshold value.

20. A method for controlling a locking apparatus in a system (100) including a power tool and at least one rechargeable battery as an energy supply for the power tool, wherein the locking apparatus includes at least one actuator for reversibly moving at least one lock from a first position into a second or third position, the method comprising the steps of:
detecting at least one acceleration value via an acceleration sensor;
comparing the at least one detected acceleration value to at least one first and second threshold value;
emitting at least one first signal to the actuator to switch the lock from the first to the second position if the at least one detected acceleration value corresponds to the first threshold value; and
emitting at least one second signal to the actuator to switch the lock from the first to the third position if the at least one detected acceleration value corresponds to the second threshold value.
